(19) United States
(12) Patent Application Publication
(10) Pub. No.: US 2017/0110928 A1
(43) Pub. Date: Apr. 20, 2017

(54) ROTARY ELECTRIC MACHINE

(71) Applicant: DENSO CORPORATION, Kariya-city (JP)

(72) Inventor: Tsuyoshi KODA, Kariya-city (JP)

(73) Assignee: DENSO CORPORATION, Kariya-city (JP)

(21) Appl. No.: 15/294,052

(22) Filed: Oct. 14, 2016

(30) Foreign Application Priority Data
Oct. 14, 2015 (JP) 2015-202608

(51) Int. Cl. H02K 5/16; H02K 1/12; H02K 7/00; H02K 1/27

(52) U.S. Cl. CPC H02K 5/161; H02K 1/2706; H02K 1/12; H02K 7/003

(57) ABSTRACT

An rotary electric machine includes a housing, a pair of bearings that are press-fitted into and supported by the housing, a rotating shaft that is press-fitted into and supported by the pair of bearings, a rotor fixed to the rotating shaft, and a stator fixed on the housing and disposed to face the rotor in a radial direction. A first notched groove and a second notched groove are disposed on at least one of a support surface of the housing to which the bearing is press-fitted and supported, and a supported surface of the rotation shaft which is press-fitted into and supported by the bearing.

### CROSS-REFERENCE TO RELATED APPLICATION

This application is based on and claims the benefit of priority from earlier Japanese Patent Application No. 2015-202608 filed Oct. 14, 2015, the description of which is incorporated herein by reference.

### TECHNICAL FIELD

The present disclosure relates to a rotary electric machine used as a motor or a generator in a vehicle.

### BACKGROUND

Conventionally, as a rotary electric machine used is on a vehicle, a device that has a housing, a rotating shaft rotatably supported by the housing via a pair of bearings, a rotor attached to the rotating shaft that rotates integrally with the rotating shaft, and a stator disposed in the housing, so as to face the rotor, is generally known.

Then, a rotary electric machine equipped with a spring washer as a preload device that applies pressure to a bearing in an axial direction of a rotating shaft via a support member that slides freely in the axial direction on the rotating shaft is disclosed in a Japanese Patent Application Laid-Open Publication No. 2013-70510.

Incidentally, in the rotary electric machine as described above, although it is effective to lower a surface pressure of the bearing in order to improve the life of the bearing, the use of the spring washer as a means for reducing the surface pressure as in the Publication No. 2013-70510 has the following problems.

(A) An axial load is applied to the bearing by using the spring washer.

According to the Publication No. 2013-70510, a so-called riding-up-on-a-shoulder, which means that a rolling element rides up on a shoulder of a bearing ring, will occur, and on the contrary to the intention of the technology disclosed, there is a case that the life of the bearing is shortened.

(B) In a case where a radial load is large, a large preload is required in order to reduce the surface pressure, thus it may be necessary to use an angular contact ball bearing instead of a deep groove ball bearing.

In general, since two angular contact ball bearings are used opposing to each other in an axial direction of a rotating shaft, a size in the axial direction becomes larger than that of the deep groove ball bearing, thus an axial length of the rotary electric machine increases.

(C) The cost is increased by the spring part being added.

(D) When assembling a ball bearing, in order to aim for improvement of the bearing life or a reduction of rattling of the rotation, it is most desirable to 0-aim, which sets the bearing clearance at the time of operation to 0.

However, when an operating time clearance is negative, the life of the bearing lowers significantly as shown in FIG. 11.

Here, a term the operating clearance becomes negative means that an inner race and balls, or the balls and an outer race constituting the ball bearing become in a state of being elastically deformed by being press-contacted to each other due to expansion or contraction during press-fitting.

Therefore, in order to lower the surface pressure, it is sufficient to increase the number of rolling elements of the bearing that receive the load applied.

In other words, a radial clearance may become smaller.

However, the radial clearance cannot be reduced more than necessary, and since the life of the bearing is lowered extremely when it becomes negative clearance as described above, the radial clearance is necessary to be used in a range of a positive clearance.

Incidentally, when a lower limit value is decided, factors that clearance becomes large are the following two points: (a) a clearance variation of the bearing itself, and (b) a variation of expansion or contraction of the clearance due to tolerance of a press-fitting portion.

Among them, (a) although there is a limit to suppress a variation of the clearance from occurring in the bearing itself, (b) it is possible to mitigate an influence of the expansion or contraction of the clearance during press-fitting.

### SUMMARY

An embodiment provides a rotary electric machine that no rolling element rides up on a shoulder of a bearing ring, and improves bearing life even when a high radial load is applied to the bearing.

In a rotary electric machine according to a first aspect, the rotary electric machine includes a housing, a pair of bearings that are press-fitted into and supported by the housing, a rotating shaft that is press-fitted into and supported by the pair of bearings, a rotor fixed to the rotating shaft, a stator fixed on the housing and disposed to face the rotor in a radial direction, and a notched groove that is disposed on at least one of a support surface of the housing to which the bearing is press-fitted and supported, and a supported surface of the rotation shaft which is press-fitted into and supported by the bearing.

According to the present configuration, the notched groove is disposed on at least one of the support surface of the housing to which the bearing is press-fitted and supported, and the supported surface of the rotation shaft which is press-fitted into and supported by the bearing.

Therefore, tensile force or contractile force acting on the housing or the rotating shaft is moderated when assembling the bearing, and clearance shrinkage factor due to the fastening margin is reduced.

Since the variation in a clearance shrinkage amount due to tolerance during the press fitting is decreased by the clearance shrinkage factor being decreased, it is possible to reduce the clearance.

Thus, it is possible to improve the bearing life even when a high radial load is applied to the bearing.

In addition, since no axial load is applied to the bearing, it is possible to avoid a riding-up-on-a-shoulder of the rolling elements from occurring.

Further, since the notched groove disposed on the support surface of the housing or the supported surface of the rotation shaft becomes an escape route for air when assembling the bearing by press fitting, it is possible to obtained an effect that press-fit load is stabilized.

In the present specification, the term “press-fitted and supported” means that it is supported in a state of pressure being applied in the radial direction.

Moreover, the term “clearance shrinkage factor” refers to a factor at which a radial clearance is decreased relative to a press-fit fastening margin by a rotating shaft and an inner race of a bearing, and a press-fit fastening margin by a housing and an outer race of the bearing.

### BRIEF DESCRIPTION OF THE DRAWINGS

In the accompanying drawings:

FIG. 1 shows a sectional view in an axial direction showing a rotary electric machine schematically according to a first embodiment;

FIG. 2 shows an enlarged sectional view enlarging a front side bearing portion of the rotary electric machine shown in FIG. 1;

FIG. 3 shows a sectional view taken along a line III-III in FIG. 2;

FIG. 4 is an explanatory view showing a direction of a load applied by a tension belt which is bridged on a pulley of the rotary electric machine of the first embodiment;

FIG. 5 is an explanatory view showing that a notched groove is disposed in a counter-load-applied direction side relative to the direction of the load applied to the pulley of the rotary electric machine of the first embodiment;

FIG. 6 is an explanatory view showing a state where a rotating shaft of a rotary electric machine according to a first modification is coaxially coupled with a rotating shaft of another rotating device;

FIG. 7 shows a perspective view of a front side bearing portion of a rotary electric machine according to a second modification seen from an inner side of a housing;

FIG. 8 shows a front view of the front side bearing portion of the rotary electric machine according to the second modification seen from the inner side of the housing;

FIG. 9 shows a perspective view of a front side bearing portion of a rotary electric machine according to a third modification seen from an inner side of a housing;

FIG. 10 shows a front view of the front side bearing portion of the rotary electric machine according to the third modification seen from the inner side of the housing; and

FIG. 11 shows a graph showing a relationship between a bearing life and an operating time clearance.

### DETAILED DESCRIPTION OF THE PREFERABLE EMBODIMENT

An embodiment of a rotary electric machine of the present disclosure will be specifically described with reference to the drawings.

Each figure illustrates elements necessary for describing the present disclosure, and it is not necessarily to illustrate all actual elements.

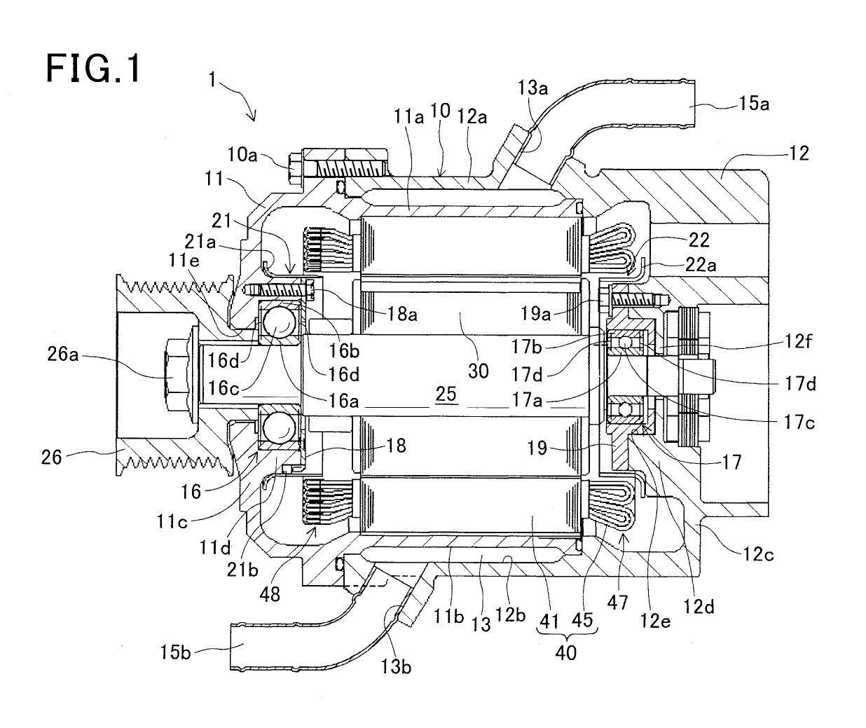

Further, in the following description, unless otherwise specified, an axial first end side means the right side of FIG. 1, and an axial second end side means the left side of FIG. 1.

Furthermore, an upper portion in a vertical direction means an upper portion of FIG. 1, and a lower portion in the vertical direction means a lower portion of FIG. 1.

### First Embodiment

A rotary electric machine 1 of the present embodiment is used as a motor in a vehicle.

As shown in FIG. 1, the rotary electric machine 1 includes a housing 10 that has a coolant flow passage 13, a pair of bearings 16 and 17 that are press-fitted into and supported by the housing 10, a rotating shaft 25 of which first and end portions are press-fitted into and supported by the pair of bearings 16, 17 respectively, a rotor 30 fixed to an outer peripheral surface of the rotating shaft 25 and disposed in the housing 10, and a stator 40 fixed on the housing 10 and disposed to face the rotor 30 in a radial direction.

The housing 10 is composed of a bottomed cylindrical front housing 11 and a bottomed cylindrical rear housing 12. The front housing 11 includes an inner cylindrical portion 11a of which an axial first end side is open. In addition, the rear housing 12 includes an outer cylindrical portion 12a of which an axial second end side (the left side in FIG. 1, the same shall apply hereinafter.) is open that is fitted on an outer peripheral side of the inner cylindrical portion 11a.

The housing 10 is assembled by fitting in the axial direction the outer cylindrical portion 12a of the rear housing 12 to the outer peripheral side of the inner cylindrical portion 11a of the front housing 11 in a state of opening sides thereof being opposed to each other.

The front housing 11 and the rear housing 12 are fastened by bolts 10a at a plurality of positions in a circumferential direction.

The coolant flow passage 13 is disposed between the inner cylindrical portion 11a of the front housing 11 and the outer cylindrical portion 12a of the rear housing 12 so as to go around in the circumferential direction at a predetermined width.

That is, a recessed groove 11b, which recesses radially inward and goes around in the circumferential direction at a predetermined width, is formed on an outer peripheral surface of the inner cylindrical portion 11a.

In addition, another recessed groove 12b, which is recessed radially outward and goes around in the circumferential direction with a predetermined width in the axial direction, is formed on a position, which faces the recessed groove 11b, of an inner peripheral surface of the outer cylindrical portion 12a.

Thereby, the coolant flow passage 13 is formed by these recessed grooves 11b and 12b.

An inlet port 13a communicating with the coolant flow passage 13 is disposed on an upper portion in a vertical direction of the outer cylindrical portion 12a of the rear housing 12.

An inlet pipe 15a is connected to the inlet port 13a, and a coolant (not shown) is introduced into the coolant flow passage 13 by a coolant supply device (not shown) with a pump or the like via the inlet tube 15a.

Further, an outlet port 13b communicating with the coolant flow passage 13 is disposed on a lower portion in the vertical direction of the outer cylindrical portion 12a of the rear housing 12.

Then, the coolant is discharged to outside from the coolant flow passage 13 via an outlet tube 15b connected to the outlet port 13b.

A cylindrical base portion 11d that projects axially inward (to the right in FIG. 1) is disposed at a central portion of a bottom portion 11c of the front housing 11.

A through hole 11e formed of a large diameter portion positioned in the axial first end side and a small diameter portion positioned in the axial second end side extending in the axial direction is disposed inside the cylindrical base portion 11d.

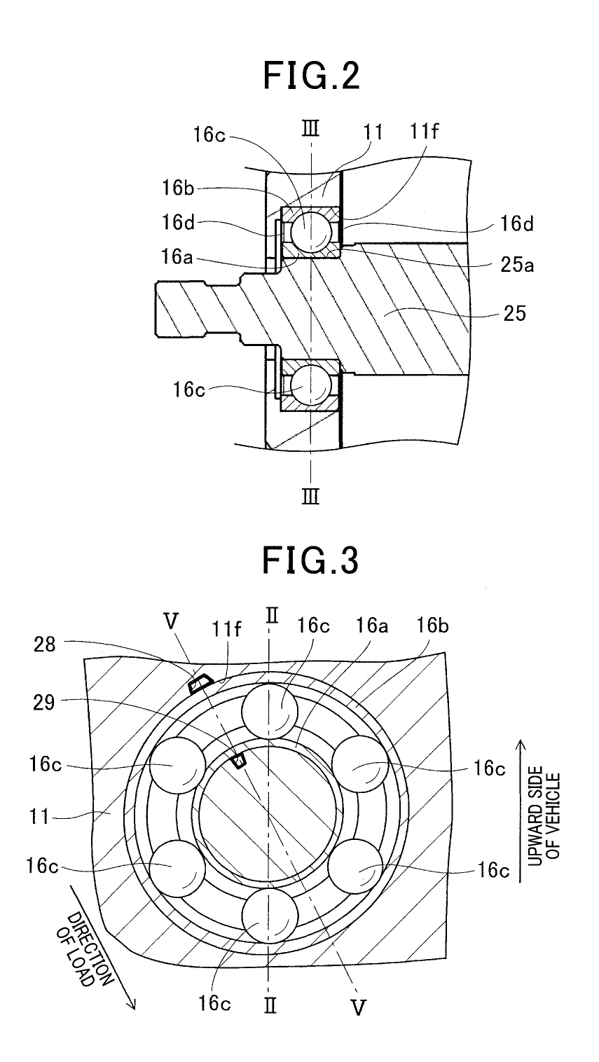

A front bearing 16 is disposed in the large diameter portion of the through hole 11e. As shown in FIGS. 2 and 3, the front bearing 16 includes an inner race 16a, an outer race 16b, a plurality of balls 16c as rolling elements, a pair of dust seals 16d, and a retainer (not shown) that retains the balls 16c.

In the present embodiment, a known deep groove ball bearing having six balls 16c is adopted as the front bearing 16.

The front bearing 16 is attached in a state in which the outer race 16b is press-fitted into and supported by the large diameter portion of the through hole 11e of the front housing 11.

In other words, the outer race 16b of the front bearing 16 is inserted into the large diameter portion of the through hole 11e of the front housing 11 in the axial direction in a state of having a fastening margin relative to the large diameter portion.

Thereby, the front bearing 16 is fixed in a state of the pressure being applied in a radial direction with respect to a peripheral wall surface of the large diameter portion that becomes a support surface 11f.

As shown in FIGS. 3 and 5, a first notched groove 28 recessing radially outward and extending in the axial direction is disposed on the support surface 11f of the front housing 11 to which the outer race 16b is press-fitted into and supported.

On the other hand, the first end portion of the rotating shaft 25 is attached in a state of being press-fitted into and supported by an inner bore of the inner race 16a of the front bearing 16.

That is, the first end portion of the rotating shaft 25 is inserted to the inner bore of the inner race 16a of the front bearing 16 in the axial direction in a state of having a fastening margin.

Thereby, the rotating shaft 25 is fixed in a state where an outer peripheral surface of the first end portion serving as a supported surface 25a under pressure being applied in the radial direction with respect to a peripheral wall surface of the inner bore of the inner race 16a of the rotating shaft 25.

As shown in FIGS. 3 and 5, a second notched groove recessing radially inward and extending in the axial direction is dispose on the supported surface 25a of the rotating shaft 25 that is press-fitted into and supported by the inner bore of the inner race 16a.

The front bearing 16 is supported by and fixed to the front housing 11 by a ring-shaped retainer plate 18 fastened by a bolt 18a to an axial first end side end face of the cylindrical base portion 11d.

A distal end portion of the first end portion of the rotating shaft 25 is projecting towards the axial second end side from the front bearing 16, and a pulley 26 is secured to an outer peripheral surface of the distal end portion by a nut 26a coaxially with the rotating shaft 25.

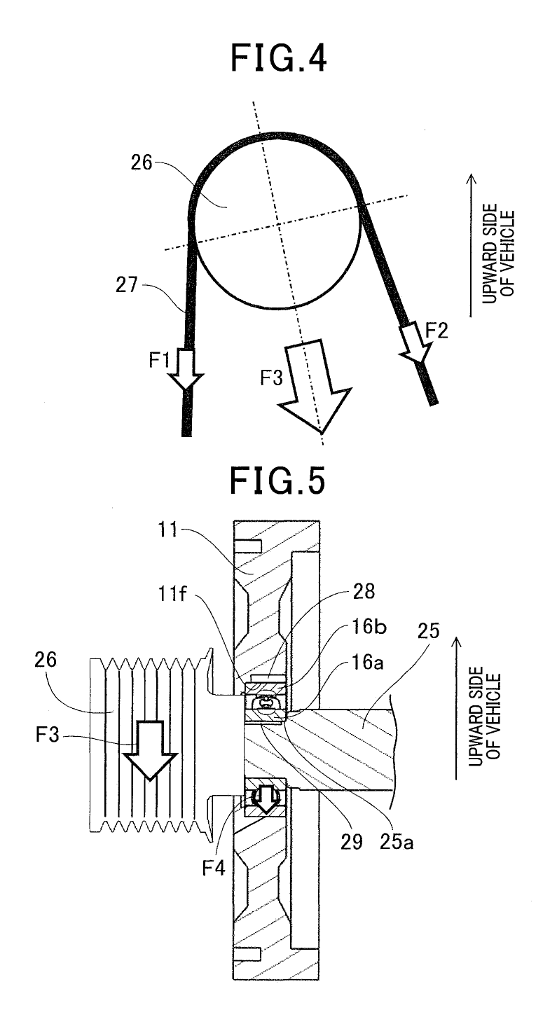

A tension belt 27 (refer to FIG. 4) for transmitting a torque of the rotating shaft 25 is bridged across the pulley 26 and another pulley (not shown) disposed on another device.

Therefore, the first and second notched grooves 28 and 29 are disposed on opposite direction sides to a direction of a load applied to the front bearing 16.

That is, in a case of the present embodiment, as shown in FIG. 4, a resultant vector F3 of tensions F1 and F2 of the tension belt 27 that is bridged across the pulley 26 acts on the pulley 26.

As shown in FIG. 5, the resultant vector F3 is applied as a load F4 with respect to the front bearing 16.

Therefore, as shown in FIG. 3, the first and second notched grooves 29 are disposed on an opposite direction side to a direction of a load applied to the front bearing 16.

Thus, the inner race 16a and the outer race 16b of the front bearing 16 are prevented from applying a bending load by being like a bridge over the first and second notched grooves 28 and 29.

Note that, as shown in FIGS. 3 to 5, the first and second notched grooves 28 and 29 are disposed on an upward side of the vehicle to which the rotary electric machine 1 is mounted.

Thus, since foreign matter such as water from the first and second notched grooves 28, 29 is prevented from entering into the housing 10, the robustness is improved.

A seal member 21 formed into a thin cylindrical shape by using an electrically insulating material such as PEEK (Polyether Ether Ketone), for example, is disposed on an outer peripheral surface of the cylindrical base portion 11d in a state of close contact with the outer peripheral surface of the cylindrical base portion 11d.

The seal member 21 has a ring-shaped flange portion 21a at the axial second end side thereof projecting radially outward.

Further, the seal member 21 has a projecting portion 21b projecting radially inward formed on an axial center portion of an inner peripheral surface, and the seal member 21 is prevented from coming out from the cylindrical base portion 11d by the retainer plate 18 that abuts the projecting portion 21b.

On the other hand, a cylindrical base portion 12d that projects axially inward (to the left in FIG. 1) is disposed at a central portion of a bottom portion 12c of the rear housing 12.

A through hole 12e extending in the axial direction is disposed inside the cylindrical base portion 12d.

A ring-shaped intermediate bottom portion 12f projecting radially inwardly is disposed on an axial intermediate portion of the through hole 12e.

Thereby, the through hole 12e has a large diameter portion positioned at the axial second end side and a small diameter portion formed by an inner bore of the intermediate bottom portion 12f.

Then, a bearing box 19 having a circular recess that is recessed in the axial first end side in a center thereof is fastened by a bolt 19a to an axial second end side end face of the cylindrical base portion 12d.

The bearing box 19 is attached in a state in which the circular recess is fitted into the large diameter portion of the through hole 12e.

A circular hole larger than the inner bore of the intermediate bottom 12f is formed coaxially with the inner bore at a center of the circular recess of the bearing box 19.

A rear bearing 17 is disposed in the circular recess of the bearing box 19. As shown in FIG. 1, the rear bearing 17 includes an inner race 17a, an outer race 17b, a plurality of balls 17c as rolling elements, a pair of dust seals 17d, and a retainer (not shown) that retains the balls 16c.

In the present embodiment, a known deep groove ball bearing having six balls 17c is adopted as the rear bearing 17.

However, as compared to the front bearing 16, a compact rear bearing 17 with a smaller outer diameter and small-sized balls 17c has been adopted.

Incidentally, a reason for adopting the front bearing 16 larger than the rear bearing 17 is that a large load acts on the second end side of the rotating shaft 25 in a direction perpendicular to the axial direction by the tension of the tension belt 27 that is bridged across the pulley 26.

The outer race 17b of the rear bearing 17 is press-fitted into and supported by a peripheral wall of the circular recess of the bearing box 19.

In other words, the rear bearing 17 is inserted into the peripheral wall surface of the circular recess of the bearing box 19 in the axial direction in a state of having a fastening margin relative to the peripheral wall surface.

Thereby, the rear bearing 17 is fixed in a state of the pressure being applied in a radial direction with respect to the peripheral wall surface of the circular recess that becomes a support surface 12g.

Then, a seal member 22 formed into a thin cylindrical shape by using the same electrically insulating material as the seal member 21 is disposed on an outer peripheral surface of the cylindrical base portion 12d in a state of close contact with the outer peripheral surface of the cylindrical base portion 12d.

The seal member 22 has a ring-shaped flange portion 22a at the axial first end side thereof projecting radially outward.

Then, the rotor 30 is fitted and fixed on an axial center portion (between the front bearing 16 and the rear bearing 17) of the outer peripheral surface of the rotating shaft 25. A plurality of magnetic poles (not shown) is disposed on the rotor 30 so as polarities thereof become different alternately in the circumferential direction by a plurality of permanent magnets (not shown) embedded in an outer periphery of the rotor 30.

Although the number of magnetic poles of the rotor 30 is not limited because it varies by a rotary electric machine, 8 poles (4 N poles, 4 S poles) of the magnetic poles are formed in a case of the present embodiment.

The stator 40 includes an annular stator core 41 having a plurality of slots (not shown) that are arranged in a circumferential direction, and a stator winding 45 that is accommodated in the slots. The stator winding 45 is composed of a three-phase winding wound around the stator core 41 in a predetermined manner.

Since the stator winding 45 in the present embodiment adopts a double-slotted distributed winding, two slots are formed for every phase of the stator winding 45 with respect to the number of magnetic poles (which is 8) of the rotor 30 in the stator core 41.

That is, 8×3×2=48 slots are formed.

The stator winding 45 wound around the stator core 41 has a first coil end 47 formed in a ring shape as a whole by a plurality of conductor wires projecting in the axial first end side of the stator core 41.

Further, the stator winding 45 has a second coil end 48 formed in a ring shape as a whole by a plurality of conductor wires projecting in the axial second end side of the stator core 41.

The rotary electric machine 1 of the present embodiment configured as described above, the rotor 30 rotates in a predetermined direction integrally with the rotating shaft 25 by the stator core 41 being magnetized when an alternating current is applied (energized) to the stator winding 45 from an inverter (not shown).

Accordingly, the torque of the rotating shaft 25 is supplied as power to other devices via the pulley 26 and the tension belt bridged over the pulley 26.

At the same time, the coolant supply device or the like disposed on a circulation path of the coolant starts its operation, and the coolant is introduced into the coolant flow passage 13 from the inlet port 13a disposed in the housing 10.

The introduced coolant flows toward the outlet port 13b of the coolant flow passage 13, and is returned to the circulation path from the outlet port 13b.

At this time, the housing 10, which is heated by heat generated in the stator windings 45, is cooled by the coolant flowing through the coolant flow passage 13.

As described above, according to the rotary electric machine 1 of the present embodiment, the first notched groove 28 or the second notched groove 29 is disposed on at least one of the support surface 11f of the front housing 11 to which the outer race 16b of the front bearing 16 is press-fitted and supported and the supported surface 25a of the rotation shaft 25 which is press-fitted into and supported by the inner race 16a of the front bearing 16.

Therefore, tensile force or contractile force acting on the front housing 11 or the rotating shaft 25 is moderated when assembling the front bearing 16, and clearance shrinkage factor due to the fastening margin is reduced.

Since the variation in a clearance shrinkage amount due to tolerance during the press fitting is decreased by the clearance shrinkage factor being decreased, it is possible to reduce the clearance.

Thus, it is possible to improve the bearing life even when a high radial load is applied to the front bearing 16.

In particular, in the present embodiment, the first notched groove 28 and the second notched groove 29 are respectively disposed on the support surface 11f of the front housing 11 and the supported surface 25a of the rotating shaft 25.

Therefore, since the clearance shrinkage can be further moderated, it is possible to further reduce the clearance between the front bearing 16 and the rotating shaft 25.

In addition, since no axial load is applied to the front bearing 16, it is possible to avoid a riding-up-on-a-shoulder of the ball 16c from occurring.

Further, since the first and second notched grooves 28 and 29 become escape routes for air when assembling the front bearing 16 by press fitting, it is possible to obtained an effect that press-fit load is stabilized.

Further, in the present embodiment, the first and second notched grooves 28 and 29 are disposed on the opposite direction sides to the direction of the load F4 applied to the front bearing 16.

Thus, it is possible to prevent the inner race 16a and the outer race 16b of the front bearing 16 from applying a bending load due to their bridging over the first and second notched grooves 28 and 29.

Further, in the present embodiment, the first and second notched grooves 28 and 29 are disposed on the upward side of the vehicle to which the rotary electric machine 1 is mounted.

Therefore, since foreign matters such as water from the first and second notched grooves 28, 29 are hardly entering into the housing 10, the robustness is improved.

### [First Modification]

It should be appreciated that, in a first modification and the subsequent modifications, components identical with or similar to those in the first embodiment are given the same reference numerals, and repeated structures and features thereof will not be described in order to avoid redundant explanation.

The above-described rotary electric machine 1 of the first embodiment has been adapted to transmit torque of the rotating shaft 25 via the pulley 26 and the tension belt 27 attached to the rotating shaft 25.

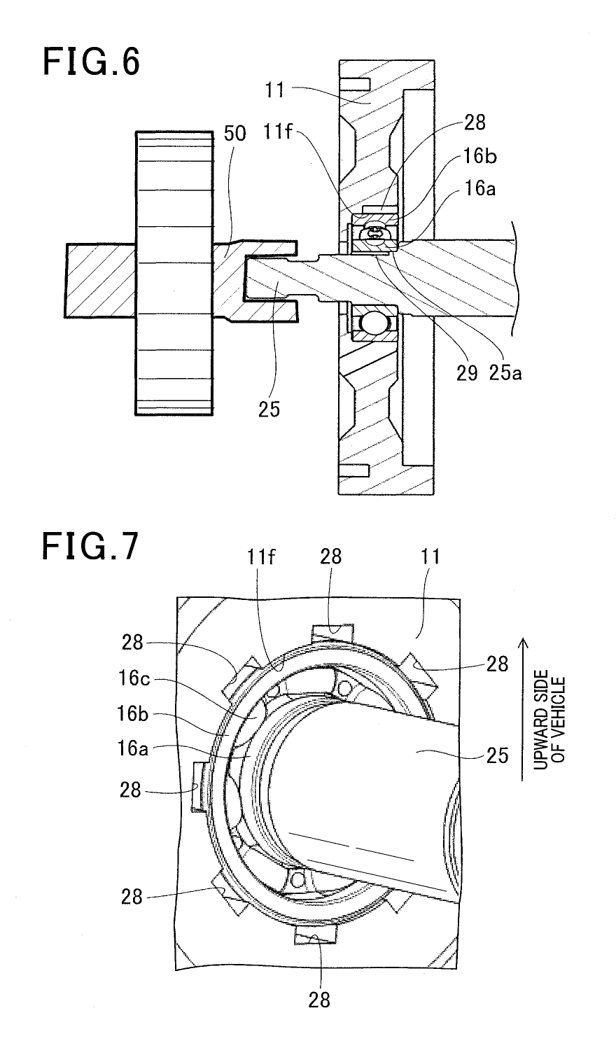

In contrast, as shown in FIG. 6, the first modification is different from the first embodiment in points that the rotation shaft 25 is connected coaxially with a rotating shaft 50 of another rotary device such as a transmission, an engine, a gearbox, an axle, or a wheel, for example.

In this case, although both rotating shafts 25, 50 are connected by a spline fitting manner, other coupling methods such as a sprocket and a chain, or gears may be employed, for example.

According to the rotary electric machine of the first modification, since the radial load acting on the rotating shaft 25 becomes small, it is possible to further improve the bearing life.

### [Second Modification]

One each of the first and second notched grooves 28 and 29 is disposed in the rotary electric machine 1 described in the first embodiment.

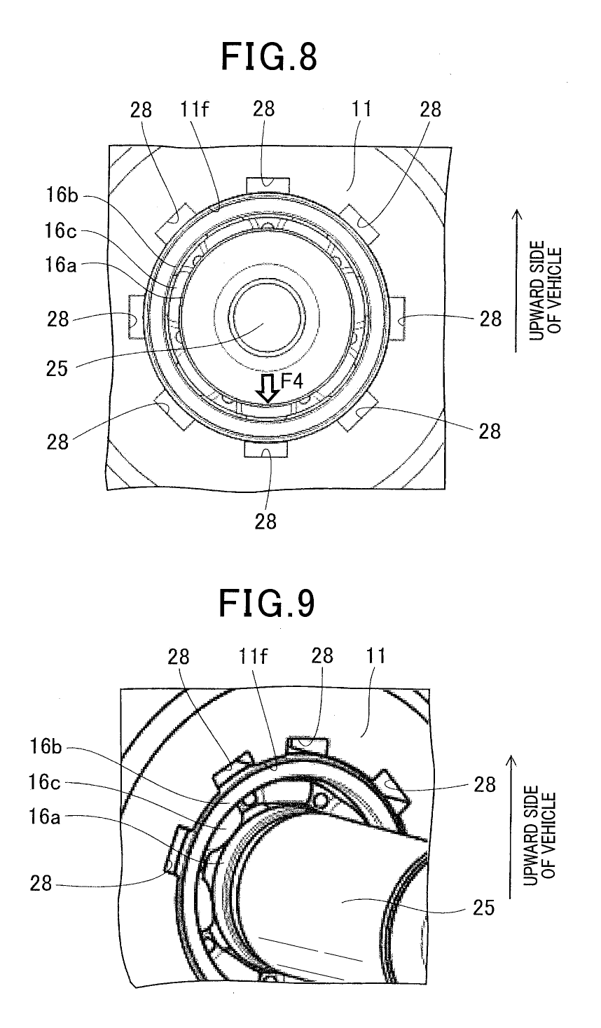

However, as in the second modification shown in FIGS. 7 and 8, a plurality of the first notched grooves 28 may be disposed along a rotating direction (the circumferential direction) of the rotating shaft 25, for example.

In a case of the second modification, eight first notched grooves 28 are disposed on an entire region of the support surface 11f of the front housing 11 at equal pitch in a circumferential direction.

Thus, a reduction effect of the clearance shrinkage of the front bearing 16 can be enhanced.

In this case, it is preferable that the number of the first notched grooves 28 (eight in the second modification) does not become divisor or multiple relative to the number of the balls 16c (seven in the second modification) of the front bearing 16.

Thus, it is possible to prevent acoustic resonance from being generated when the balls 16c are passing through positions of the first notched grooves 28.

In a case where the pulley 26 and the tension belt 27 are adopted as in the first embodiment, the plurality of first notched grooves 28 arranged at the equal pitch may be disposed on the opposite direction side to the direction of the load F4 applied to the front bearing 16.

Further, in this case, it is preferable that the plurality of first notched grooves 28 arranged at the equal pitch to be disposed on the upward side of the vehicle to which the rotary electric machine is mounted.

It should be noted that although only the first notched groove 28 has been described in the second modification, the second notched groove 29 disposed on the supported surface 25a of the rotating shaft 25 can also be disposed similarly to the first notched groove 28.

### [Third Modification]

The eight first notched grooves 28 have been arranged at the equal pitch in the circumferential direction on the support surface 11f of the front housing 11 in the above second modification.

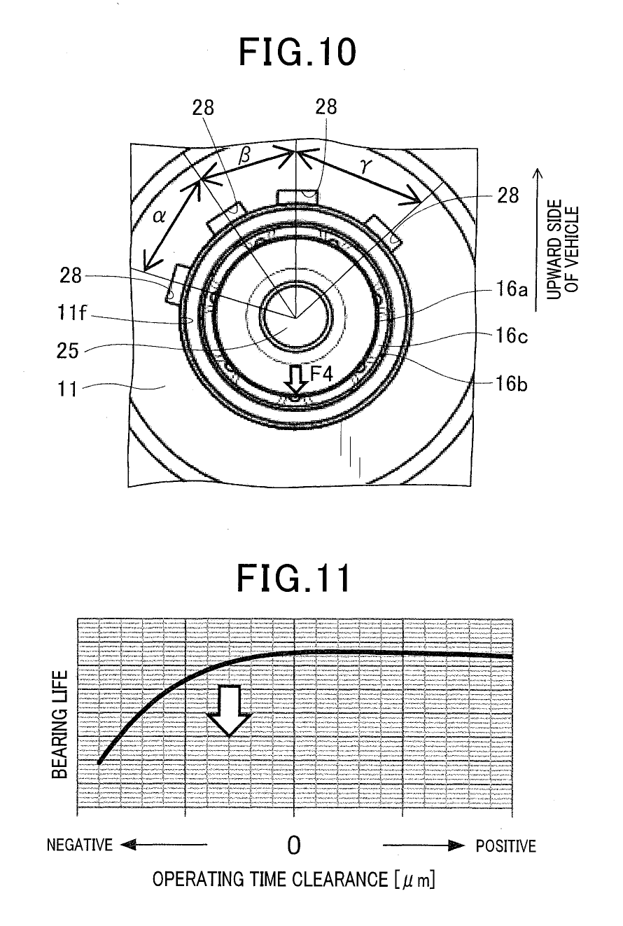

However, as in a third modification shown in FIGS. 9 and 10, a plurality of first notched grooves 28 may be disposed in the rotational direction (the circumferential direction) of the rotating shaft 25 at irregular pitches.

In a case of the third modification, four first notched grooves 28 are arranged at irregular pitches in the circumferential direction.

That is, as shown in FIG. 10, separation angles α, β, γ between the two first notched grooves 28 circumferentially adjacent are all different.

Thereby, it is possible to prevent a resonance of a sound from being generated when the balls 16c are passing through positions of the first notched grooves 28.

Further, the four first notched grooves 28 are disposed on the opposite direction side to the direction of the load F4 applied to the front bearing 16 by a pulley and a tension belt (not shown).

Furthermore, the four first notched grooves 28 are disposed on the upward side of the vehicle to which the rotary electric machine is mounted. Thus, it is possible to obtain the same advantageous effects as the first embodiment.

### OTHER EMBODIMENTS

The present disclosure is not limited in any way to the embodiment or modifications described above, and may be implemented in various modifications without departing from the scope of the present disclosure.

For example, both the first and second notched grooves 28 and 29 are disposed on the front bearing 16 in the first embodiment described above.

However, in the present disclosure, at least one of the first and second notched grooves 28 and 29 may be disposed.

Further, the first and second notched grooves 28 and 29 are disposed only in the front bearing 16 in the first embodiment described above.

However, in the present disclosure, it is possible to dispose at least one of the first and second notched grooves 28 and 29 on at least one of the front bearing 16 and the rear bearing 17.

Further, a deep groove ball bearing has been employed as the front bearing 16 and the rear bearing 17 in the first embodiment described above.

However, in the present disclosure, it is possible to suitably adopt other ball bearings or rolling bearings classified as roller bearings or the like.

Incidentally, an example of a vehicle electric motor as a rotary electric machine is described in the first embodiment.

However, the present disclosure can be applied to any device as long as it has a member that rotates such as a shaft, for example.

For example, a generator, an electric motor, or a motor-generator, etc. may correspond to such a device.

The generator includes a case where the motor-generator operates as a generator, and the electric motor includes a case where the motor-generator operates as an electric motor.

What is claimed is:

1. A rotary electric machine comprising:
a housing;
a pair of bearings that are press-fitted into and supported by the housing;
a rotating shaft that is press-fitted into and supported by the pair of bearings;
a rotor fixed to the rotating shaft;
a stator fixed on the housing and disposed to face the rotor in a radial direction; and
a notched groove that is disposed on at least one of a support surface of the housing to which the bearing is press-fitted and supported, and a supported surface of the rotation shaft which is press-fitted into and supported by the bearing.

2. The rotary electric machine according to claim 1, wherein,
the notched groove is disposed on an opposite direction side to a direction of a load applied to the bearing.

3. The rotary electric machine according to claim 1, wherein,
the notched groove is disposed on an upward side of a vehicle to which the rotary electric machine is mounted.

4. The rotary electric machine according to claim 1, wherein,
the rotation shaft is connected coaxially with a rotating shaft of another rotary device.

5. The rotary electric machine according to claim 1, wherein,
a plurality of notched grooves are disposed in a rotational direction of the rotating shaft.

6. The rotary electric machine according to claim 5, wherein,
the plurality of notched grooves are arranged at irregular pitches in the rotational direction of the rotating shaft.

7. The rotary electric machine according to claim 1, wherein,
the notched groove is disposed on both the housing and the rotating shaft.
